(19) United States
(12) Patent Application Publication
(10) Pub. No.: US 2019/0186193 A1
(43) Pub. Date: Jun. 20, 2019

(54) BARRIER FOR ROUGH OPENINGS IN CONSTRUCTION SITES

(71) Applicant: Robert W. D'Angelo, JR., Naples, FL (US)

(72) Inventor: Robert W. D'Angelo, JR., Naples, FL (US)

(21) Appl. No.: 15/848,401

(22) Filed: Dec. 20, 2017

(51) Int. Cl. E06B 9/06; E05B 73/00; E05C 19/00

(52) U.S. Cl. CPC E06B 9/0692; E05C 19/00; E05B 73/0005

(57) ABSTRACT

A temporary barrier (1) for rough openings (2) of structures during construction, such as garage doors, entry doors and windows. The barrier is constructed out of a flexible panel (5) that is attached to a frame (15) of an opening via a plurality of grommets (14) spaced apart along edges of the panel. The barrier is capable of being adapted to fit over rough openings that do not provide surfaces for direct attachment, such as concrete floors, using a cable (17). One or more zippers (21) allows the barrier to be opened for entry, exit and/or air flow.

### FIELD OF THE INVENTION

This invention relates to security devices and safety barriers for construction sites and more particularly a barrier for covering rough openings in a structure, such as garage doors, entry doors and windows during the construction process.

### BACKGROUND OF THE INVENTION

Construction sites are frequently victimized by vandalism or the theft of machinery, equipment, tools, and materials. In addition, construction sites can be attractive nuisances for trespassers, such as neighbors and/or juveniles, merely interested in looking around a job site and inspecting a building while under construction.

Many buildings are open to entry by unauthorized individuals and to the elements for extended periods of time while waiting for permanent doors and windows to be installed. These rough openings may be sealed using plywood which is screwed into place over garage doors, entry doors, and/or windows. However, this is a time consuming process that requires a large amount of hard material and labor to put up and take down every day.

Therefore, a need exists for a barrier for covering rough openings in a structure, such as garage doors, entry doors, and windows during the construction process that does not have to be fully removed to gain entry, exit and/or airflow through the opening.

### SUMMARY OF THE INVENTION

The primary object of the present invention is to provide a barrier for covering rough openings in a structure, such as garage doors, entry doors, and windows during the construction process that does not have to be fully removed to gain entry, exit and/or airflow through the opening.

The present invention fulfills the above and other objects by providing a temporary barrier for rough openings of structures during construction, such as garage doors, entry doors and windows. The barrier is a flexible panel that is attached to a frame of an opening via a plurality of grommets spaced apart along edges of the panel. The grommets may be secured to the wooden frame of a rough opening via screws or other fastening devices. At least one edge of the panel is left unattached to the frame of the rough opening in instances where one edge of the opening does not provide any attachment points, such as a concrete garage floor, a threshold of a door, a concrete header and so forth. The unattached edge is preferably supported by a cable that traverses the unattached edge. The unsecured edge and cable allows a central portion of the panel to be opened using one or more zippers. When the one or more zippers are opened, the central portion of the panel may be rolled out of the way and stored in a retracted position.

Locking brackets, such as eyelets, U-bolts, and so forth, are preferably secured to the frame of the rough opening at opposing sides of the unattached edge to support the cable. In addition, the locking brackets provide an attachment point for one or more locks that secure the one or more zippers in closed and locked positions.

The panel may be made of a weather resistant material, such as plastic and/or metal mesh or equivalent material that is difficult to cut through in order to provide additional security.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective side view of a barrier of the present invention installed on a rough opening of a garage door and in a closed position;

FIG. 2 is a perspective side view of a barrier of the present invention installed on a rough opening of a garage door and in an open position;

FIG. 3 is a rear view of a barrier of the present invention installed on a rough opening of a window and in a closed position; and

FIG. 4 is a rear view of a barrier of the present invention installed on a rough opening of a window and in an open position.

### DESCRIPTION OF THE PREFERRED EMBODIMENTS

For purposes of describing the preferred embodiment, the terminology used in reference to the numbered accessories in the drawings is as follows:
1. barrier, generally
2. rough opening
3. garage door
4. window
5. panel
6. perimeter edge of panel
7. top edge of panel
8. first side edge of panel
9. second side edge of panel
10. bottom edge of panel
11. front surface of panel
12. rear surface of panel
13. aperture
14. grommet
15. frame
16. screw
17. cable
18. first side of rough opening
19. second side of rough opening
20. locking bracket
21. zipper
22. lock
23. central portion of panel
24. tieback
25. alarm
26. wire

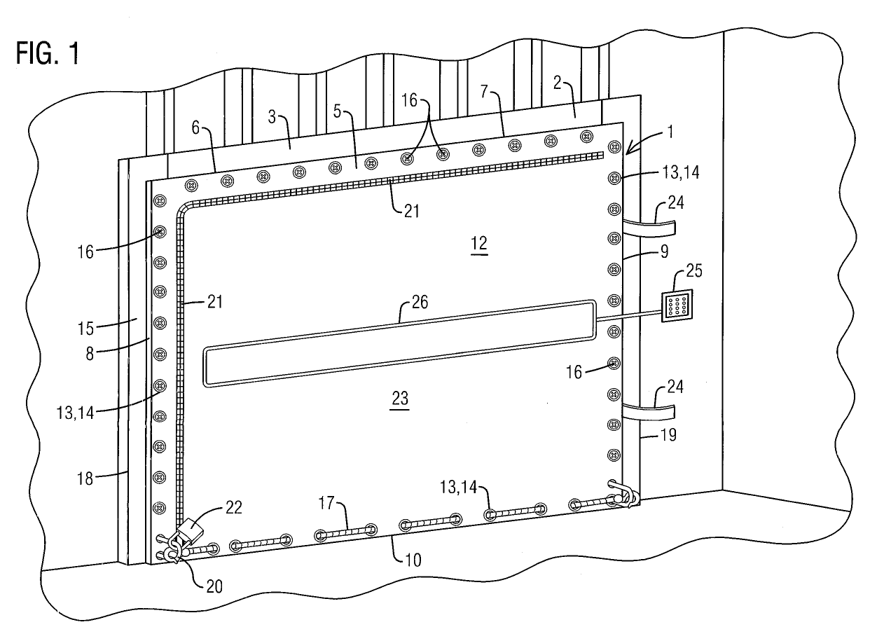

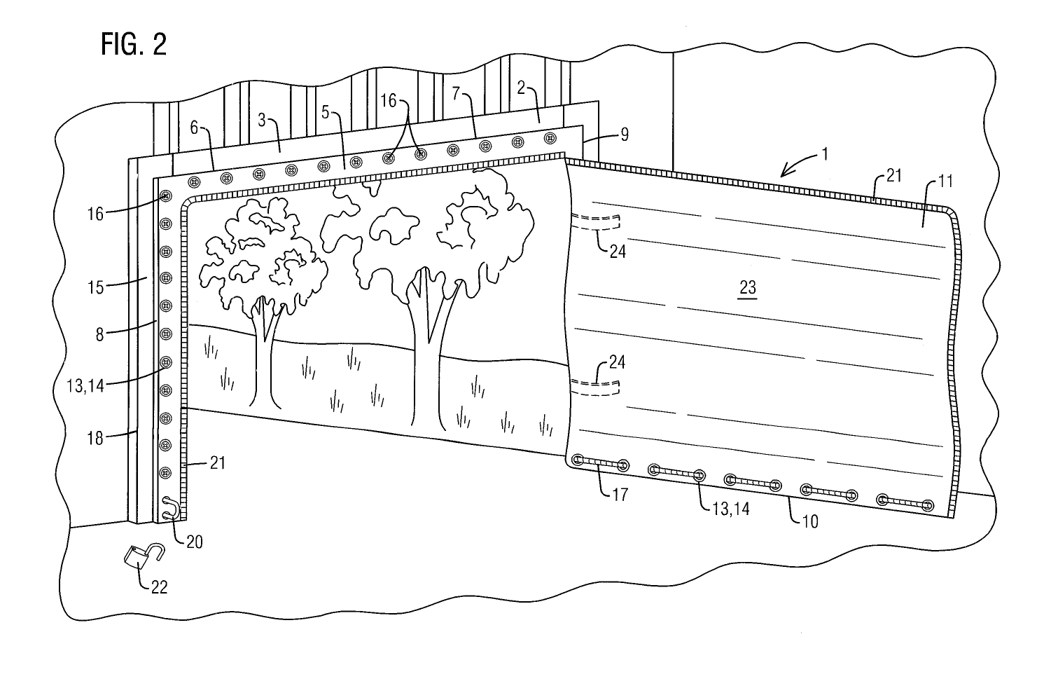

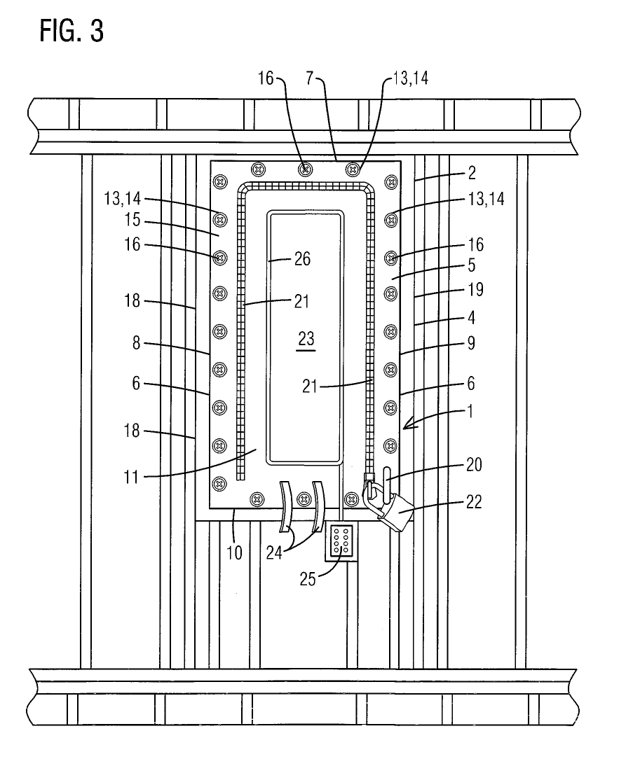

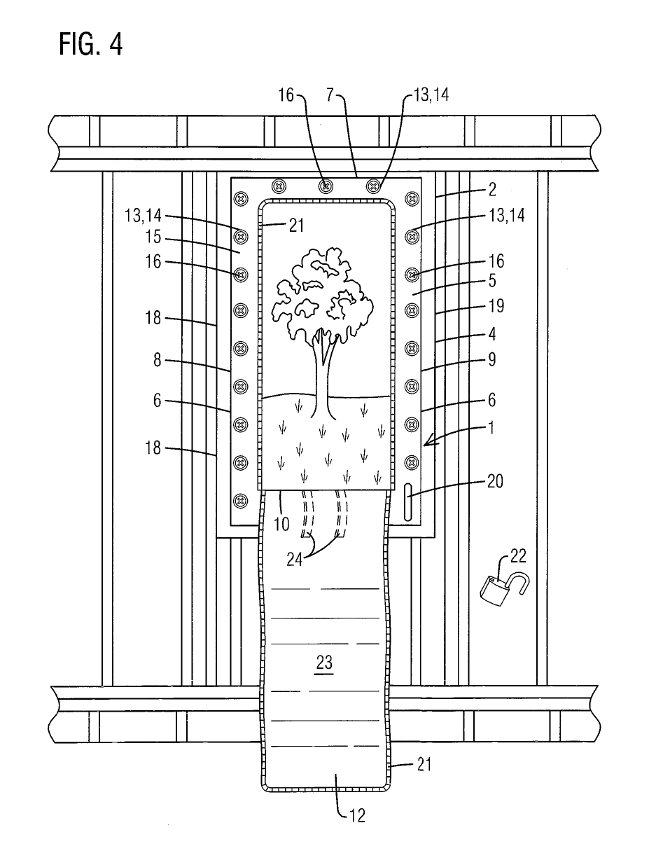

With reference to FIGS. 1-4, a barrier 1 of the present invention used for covering rough openings 2 of structures during construction, such as a garage door 3, as illustrated in FIGS. 1 and 2, or a window 4, as illustrated in FIGS. 3 and 4, is illustrated. The barrier 1 preferably comprises a rectangular-shaped panel 5 having a perimeter edge 6 comprising a top edge 7, a first side edge 8, a second side edge 9, a bottom edge 10, a front surface 11 and a rear surface 12.

A plurality of apertures 13, such as reinforced grommets 14, are spaced apart along the edges of the panel 5.

As illustrated in FIGS. 1-4, the grommets 14 are located along the top edge 7, the first side edge 8, the second side edge 9, and the bottom edge 10. The edges may be secured to a frame 15 of a rough opening 2 via screws 16 or other fastening means and the grommets 14. For situations where the rough opening 12 provides a surface for the bottom edge 10 of the panel 5 to be attached using screws 16, then the top edge 7, the first side edge 8, the second side edge 9, and the bottom edge 10 are all secured to the rough opening 2 using screws 16. This is illustrated in FIGS. 3 and 4, wherein the rough opening 2 of a window 4 provides a wooden sill for securing the bottom edge 10 using screws 16.

As illustrated in FIGS. 1 and 2, the rough openings 2 do not provide a surface for the bottom edge 10 of the panel 5 to be attached to using screws 16. For example, FIGS. 1 and 2 illustrate a concrete garage floor. Thus, the unattached bottom edge 10 is preferably supported by a cable 17 that traverses the unattached bottom edge 10 and extends the length of the bottom edge 10. Alternatively, a cable 17 may be fixedly or slideably attached to the bottom edge 10 preferably by lacing the cable 17 through the grommets 14 located adjacent to the bottom edge 10. Ends of the cable 17 are then secured to a first side 18 of the rough opening 2 and a second side 19 of the rough opening 2 using locking brackets 20, such as eye screws, U bolts and so forth, preferably located at lower corners of the panel 5 that support the cable 17 in an extended position.

At least one zipper 21 is located parallel to the first side edge 8 and top side edge 7 to allow a central portion 23 of the panel 5 to be opened. As illustrated in FIG. 2, the zipper 21 may be opened and the cable 17 may be released from one of the locking brackets 20 so that the central portion 23 of the panel 5 may be retracted to one side of the rough opening 2 to allow the rough opening 2 to be used as an entry and exit. As illustrated in FIG. 4, the at least one zipper 21 is located parallel to the first side edge 8, second side edge 9 and top side edge 7 to allow a central portion 23 of the panel 5 to be opened downward to allow for air flow though the rough opening 2 of the window 4. The at least one zipper 21 may be locked into a closed position, using a locking bracket 20 and a lock 22 that engages the at least one zipper 21 and the locking bracket 20. The panel 5 may be rolled into a stored position and maintained in a stored position using one or more tiebacks 24, which may be tied around the rolled panel 5 or secured using an attachment means, such as a hook and loop fastener.

The flexible panel 5 may be made of a weather resistant material, such as plastic and/or metal mesh or equivalent material that is difficult to cut through in order to provide additional security and protection from rain and other inclement weather. An additional feature of the present invention may comprise an audible alarm 25 that emits an alert when a circuit is broken. The circuit may be created by one or more wires 26 extending horizontally and/or vertically across the barrier 1 and connected the alarm 25, as illustrated in FIGS. 1 and 3. When one of the wires is cut 26, the circuit is broken and the alarm 25 is activated.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A barrier for covering rough openings of structures during construction, said barrier comprising:
a rectangular-shaped panel having a top edge, a first side edge, a second side edge, a bottom edge, a front surface and a rear surface;
a plurality of apertures spaced apart along edges of the rectangular-shaped panel; and
at least one zipper located on the panel parallel to the first side edge and parallel to the top side edge to allow a central portion of the panel to be opened.

2. The barrier of claim 1 further comprising:
at least one zipper located on the panel parallel to the second side edge.

3. The barrier of claim 1 further comprising:
a cable attached to the bottom edge of the panel; and
said cable extending the length of the bottom edge of the panel.

4. The barrier of claim 3 wherein:
said cable is fixedly attached to said panel.

5. The barrier of claim 3 wherein:
said cable is slideably attached to said panel.

6. The barrier of claim 1 wherein:
said plurality of apertures are grommets.

7. The barrier of claim 3 further comprising:
at least one locking bracket located on said panel used for supporting the cable in an extended position.

8. The barrier of claim 1 further comprising:
at least one locking bracket located on said panel used for locking the zipper in a closed position.

9. The barrier of claim 8 further comprising:
at least one lock for engaging the at least one locking bracket.

10. The barrier of claim 1 further comprising:
at least one audible alarm connected to the panel.

11. A barrier for covering rough openings of structures during construction, said barrier comprising:
a rectangular-shaped panel having a top edge, a first side edge, a second side edge, a bottom edge, a front surface and a rear surface;
a plurality of apertures spaced apart along edges of the rectangular-shaped panel;
at least one zipper located on the panel parallel to the first side edge and parallel to the top side edge to allow a central portion of the panel to be opened; and
at least one locking bracket located on said panel used for locking the zipper in a closed position.

12. The barrier of claim 11 further comprising:
at least one zipper located on the panel parallel to the second side edge.

13. The barrier of claim 11 further comprising:
a cable attached to the bottom edge of the panel; and
said cable extending the length of the bottom edge of the panel.

14. The barrier of claim 13 wherein:
said cable is fixedly attached to said panel.

15. The barrier of claim 13 wherein:
said cable is slideably attached to said panel.

16. The barrier of claim 11 wherein:
said plurality of apertures are grommets.

17. The barrier of claim 13 further comprising:
at least one locking bracket located on said panel used for supporting the cable in an extended position.

18. The barrier of claim 11 further comprising:
at least one lock for engaging the at least one locking bracket.

19. The barrier of claim 11 further comprising:
at least one audible alarm connected to the panel.
